(19) United States
(12) Patent Application Publication
(10) Pub. No.: US 2026/0176911 A1
(43) Pub. Date: Jun. 25, 2026

(54) Method and System for Actuating a Motor Vehicle Closure Device

(71) Applicant: Bayerische Motoren Werke Aktiengesellschaft, Muenchen (DE)

(72) Inventors: Daniel Kuelzer, Muenchen (DE); Alexander Ewald, Muenchen (DE)

(21) Appl. No.: 18/726,932

(22) PCT Filed: Dec. 6, 2022
(86) PCT No.: PCT/EP2022/084546

§ 371 Date: Jul. 5, 2024

(30) Foreign Application Priority Data
Apr. 4, 2022 (DE) 10 2022 107 937.6

(51) Int. Cl. E05F 15/76; B60K 15/04

(52) U.S. Cl. CPC E05F 15/76; B60K 15/0409; B60K 2015/0416

(57) ABSTRACT

A method for actuating a motor vehicle closure device of a motor vehicle is disclosed herein. The method includes detecting a current first position of the motor vehicle based on a signal from a position detection device of the motor vehicle, and determining a distance of the motor vehicle from an energy source for the motor vehicle for filling an energy storage device of the motor vehicle. The method also includes determining a second position of a mobile access authorization device for a person to the motor vehicle based on a signal from a further position detection device of the access authorization device. The method further includes actuating the motor vehicle closure device using a controller of the motor vehicle closure device when the motor vehicle is within a predetermined first distance threshold from the energy source and when the second position is within a second predetermined distance threshold from the motor vehicle closure device.

### CROSS-REFERENCE TO RELATED APPLICATIONS

The present application is the U.S. national phase of PCT Application PCT/EP2022/084546 filed on Dec. 6, 2022, which claims priority to German patent application No. 10 2022 107 937.6 filed on Apr. 4, 2022, the entire contents of which are incorporated herein by reference.

### TECHNICAL FIELD

The disclosure relates to the field of motor vehicles and an associated method for actuating a motor vehicle closure device.

### BACKGROUND

It is already known from the prior art that motor vehicle closures, such as fuel filler flaps or charging flaps, can be opened automatically or mechanically in order to gain access to a filling neck, for example. Particularly in the case of petrol stations or charging stations, a corresponding nozzle can then be inserted into an opening, for example to refuel the vehicle with electrical energy or fluidic fuel. Appropriate mechanical closure devices are already known for this purpose, which allow, for example, the flap to pop open in order to be able to achieve easy access. However, it is always necessary for the person to operate the fuel filler flap accordingly. For example, in the case of a dirty vehicle, this can lead to the person getting correspondingly dirty fingers.

DE 10 2009 058 864 B4 discloses a method for actuating a motor vehicle closure which has a closure part that can be moved by means of a drive device and with which the mouth of a fuel filler neck can be closed, wherein a sensor device is activated by switching on an activation device, which has a proximity sensor located in the vicinity of the closure part, wherein the activated sensor device sends an opening signal to the actuator device for opening the closure part when an approaching person and/or any object moves to within a predetermined distance from the proximity sensor and that the activated sensor device emits a closing signal to the actuator device to close the closure part when the person and/or object moves beyond the predetermined distance from the proximity sensor.

### SUMMARY

A method and associated computer program product for a motor vehicle closure device is disclosed herein by means of which convenient access for the person can be realized during a filling process.

One aspect of the present disclosure relates to a method of actuating a motor vehicle closure device of a motor vehicle. A current first position of the motor vehicle is detected based on a signal from a position detection device of the motor vehicle. A distance will be determined between the motor vehicle and an energy source for the motor vehicle for the purpose of filling an energy storage device of the motor vehicle. A second position of a mobile access authorization device for a person to the motor vehicle is determined based on a signal from a further position detection device of the access authorization device. If the motor vehicle is within a predetermined first distance threshold from the energy source and if the second position is within a second predetermined distance threshold from the motor vehicle closure device, then the motor vehicle closure device is actuated by means of an electronic computing device of the motor vehicle closure device.

This makes it possible to have convenient access for the person, especially the person carrying the mobile access authorization device.

In particular, a so-called hands-free operation of the motor vehicle closure device can be realized. Furthermore, by detecting the position of the person by means of the mobile access authorization device, recognition of the filling intention can be realized, whereby minimization of false triggering can be realized.

For example, the mobile access authorization device can be a key element, a mobile terminal, in particular a mobile phone or a smart phone or a smart watch. Here, different “car connectivity” options can be provided, for example, according to the CCC (Car Connectivity Consortium) criterion. By the position recognition of the person by means of the mobile access authorization device, the intention to fill is again determined. The position of the vehicle is compared with a database of known energy sources, such as charging points or petrol stations. The known charging points can include, for example, a fast-charging network, or previous charging points of the user or the motor vehicle. If the position of the person indicates that he or she is in the vicinity of the motor vehicle closure device and is close to the power source of the motor vehicle through the comparison, it can be seen that, for example, a filling process is planned. In this case, for example, a distance of two meters from the motor vehicle closure device can be realized as a second distance threshold. In the event of false triggering despite the detection of energy sources, which can be detected, for example, based on the continued trajectory of the person, the motor vehicle closure device closes automatically again.

The motor vehicle can be a motor vehicle with an internal combustion engine or a motor vehicle with an electric drive. Furthermore, it can also be a so-called hybrid vehicle. In particular, the motor vehicle with the internal combustion engine has, for example, a fuel filler flap, which in the present example can then be regarded as a motor vehicle closure device. The energy storage unit can then be in the form of a tank. If, for example, the motor vehicle is in the form of an electric motor vehicle, the motor vehicle closure device may also be referred to as a charging flap. The energy storage unit can then be in the form of an electrical energy storage device, for example a traction battery. If, for example, the motor vehicle is in the form of a hybrid vehicle, the motor vehicle may have both an appropriate fuel filler flap and an appropriate charging flap, as well as an appropriate tank and an appropriate electrical energy storage device. Here it may also be envisaged, for example, that the position of the person in relation to the charging flap or the fuel filler flap is used to determine whether electric charging or fluidic charging is intended.

Furthermore, it can be provided that the filling level of the tank or the electrical energy storage system can also be taken into account. If, for example, the motor vehicle is approaching an energy source, but if it is almost full, it can be assumed, for example, that there will be no refueling. In this way, the actuation of the motor vehicle closure device can be inhibited. Furthermore, it can also be checked, for example, whether conditioning of the electrical energy storage system has taken place due to a search for or input of a charging station, which can be used to draw conclusions about future charging process. Preconditioning by the user without entering a charging station can also be taken into account.

In order to continue to cover cases where, for example, the mobile access authorization device does not approach the motor vehicle closure device, mechanical opening of the motor vehicle closure device may also be provided. In particular, it is possible to provide comfortable access for the person to the motor vehicle closure device.

In particular, it may also be provided where, for example, the motor vehicle is locked, for locking or closing of the motor vehicle closure device to also be carried out. Furthermore, before the motor vehicle closure device can be opened, authentication or verification of the user or person may also be carried out as to whether this person is even authorized to carry out a corresponding filling.

As an alternative or in addition to the distance thresholds, other information, such as the orientation of the motor vehicle and the type of charging point, can also be taken into account in order to open the charging flap or fuel filler flap. In addition to so-called geofencing, an angle of movement and/or speed of the person can also be taken into account.

According to an advantageous design, the motor vehicle closure device is opened as an actuation. In other words, it is envisaged that if the person approaches, in particular, the motor vehicle closure device, it will be opened so that, for example, a filling nozzle can be released, so that convenient access can be achieved during a filling operation.

It is also advantageous if a trajectory of the person is determined depending on the second position and the motor vehicle closure device is actuated depending on the trajectory. In this way, a direction of movement of the person can also be determined, wherein then, if the person moves towards the motor vehicle closure device, it can be opened accordingly.

Thus, an independent aspect of the disclosure also concerns that the motor vehicle closure device can be opened independently of the second distance threshold if, for example, a trajectory is determined which is guiding the person towards the motor vehicle closure device.

It has also been shown to be advantageous if the motor vehicle closure device is provided for a fuel filler flap of a fluidic energy storage device and/or for a charging flap of an electrical energy storage device. The fluidic energy storage device can be a gasoline tank, diesel tank or even a hydrogen tank, for example. Thus, the motor vehicle can be in a form with an internal combustion engine as well as with an electrical energy storage device. The combination, i.e. a hybrid vehicle, is also possible.

It is also advantageous if, after a specified period of time after the motor vehicle closure device has been actuated, an automated closing of the motor vehicle closure device is carried out. If, for example, the motor vehicle is in the vicinity of a power source and at the same time the person is in the vicinity of the motor vehicle closure device, it can be opened accordingly. If, however, there is no loading or filling process, for example, the vehicle locking device can be closed automatically.

It is also advantageous if locking of the motor vehicle closure device is inhibited during a process of filling the energy storage device. In particular, it is possible to prevent the vehicle closure device from being closed during the filling process. After the filling process, the vehicle closure device can then be closed automatically after a specified period of time.

In another advantageous design example, the energy source and/or the person is/are also detected by means of a detection device of the motor vehicle and taken into account when actuating the motor vehicle closure device. For example, an optical detection device, such as a camera, can be used to detect a petrol pump or a charging station. Furthermore, alternatively or additionally the person can also be detected. In particular, a movement of the person towards the motor vehicle closure device can then again be detected. This can also be used to reliably open the motor vehicle closure device for a filling process.

According to another advantageous design, a position of the energy source is compared with the current first position of the motor vehicle on the basis of a digital map and the distance from the energy source is determined on the basis of this. For example, the digital map can be provided with the appropriate energy sources, or energy sources that have already been used in the past can be entered into the digital map. Thus, a so-called geofence can be reliably created with regard to the energy source, from when the motor vehicle is considered to be in the vicinity of the energy source.

The method presented is a computer-implemented method. Therefore, a further aspect of the disclosure relates to a computer program product with program code means which induces an electronic computing device to carry out a method according to the preceding aspect.

Another aspect of the disclosure also concerns a computer-readable storage medium with the computer program product.

Further, the disclosure relates to a motor vehicle closure device for a motor vehicle, with at least one electronic computing device, wherein the motor vehicle closure device is designed to carry out a method according to the preceding aspect. In particular, the method is carried out by means of the motor vehicle closure device.

For example, the electronic computing device (which may also be referred to herein as a “control unit” or “controller”) has processors (which may also be referred to herein as “microprocessors”), circuits, especially integrated circuits, and other electronic components in order to be able to carry out corresponding steps of the method. Electronic computing devices may include circuits that contain typical functionality of central processing units (CPU) and are configured to perform various calculations and analysis based on manufacturer and/or third party programming. Additional examples of electronic computing devices used in vehicles include any of various Engine Control Units (ECNs) and related devices which and commonly used by different manufacturers in modern automobiles.

The motor vehicle may be a motor vehicle with an internal combustion engine and/or with an electric drive device.

Further features of the disclosure arise from the claims, features and combinations of features mentioned above in the description, as well as the features and combinations of features mentioned below in the description of the figures and/or shown in the figures alone, can be used not only in the combination given in each case, but also in other combinations or on their own.

### BRIEF DESCRIPTION OF THE DRAWINGS

The disclosure is now explained in more detail on the basis of a preferred exemplary embodiment and with reference to the drawings. In the figures:

FIG. 1 shows a schematic plan view of an embodiment of a motor vehicle with an embodiment of a motor vehicle closure device; and

FIG. 2 shows a schematic top view of a digital map.

In the figures, identical or functionally identical elements are provided with the same reference signs.

### DISCLOSURE

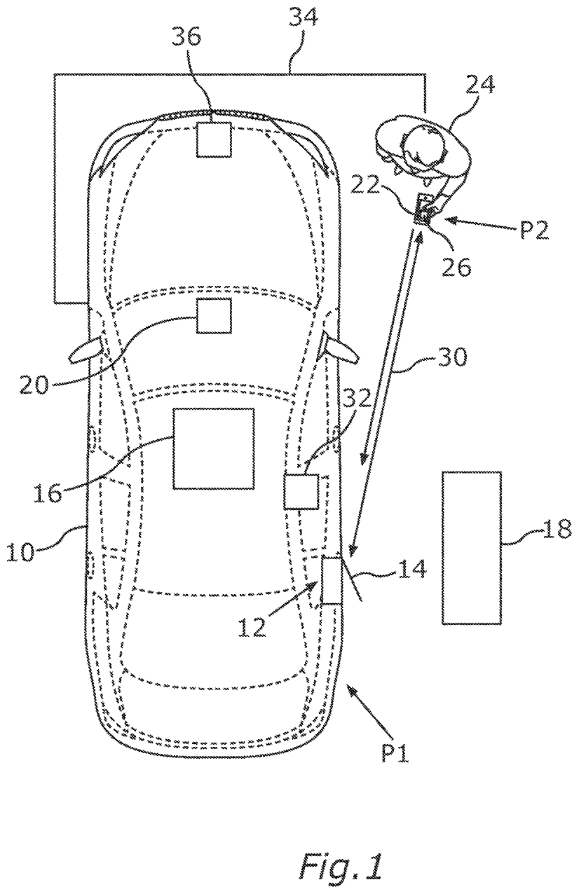

FIG. 1 shows a schematic plan view of an embodiment of a motor vehicle 10 with an embodiment of a motor vehicle closure device 12. In particular, in the present case, the motor vehicle closure device 12 is fitted with a charging flap 14. In other words, in the present case, the motor vehicle 10 is in the form, inter alia, of an electrically powered motor vehicle 10. The motor vehicle 10 has an energy storage device 16, in the present case an electrical energy storage device 16. An energy source 18, which can be in the form of a charging station, for example, can be used to charge the electrical energy storage device 16 via the motor vehicle closure device 12.

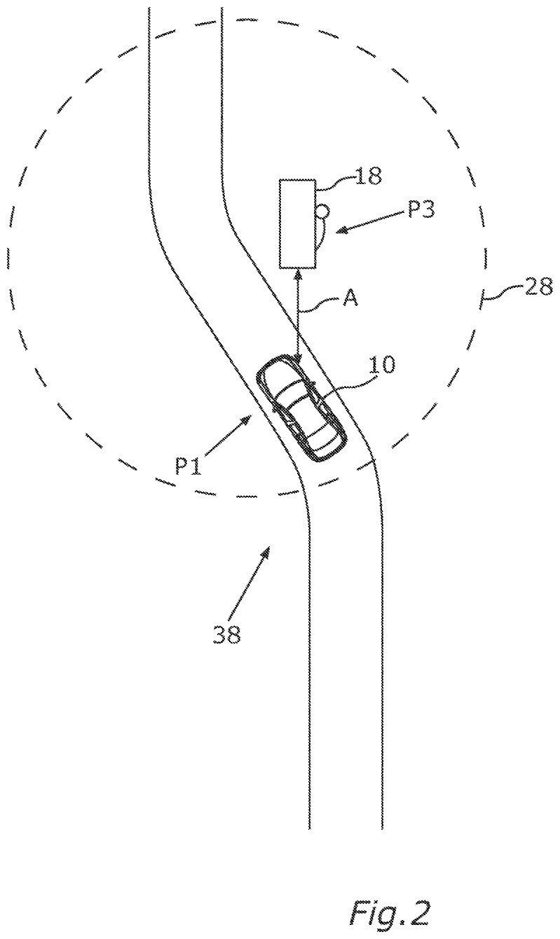

In a method according to the disclosure, it is envisaged that the motor vehicle closure device 12 is actuated automatically. In this case, a first position P1 of the motor vehicle 10 is detected by means of a position detection device 20 (i.e., a signal from the detection device), in particular of the motor vehicle 10. A distance (FIG. 2) of the motor vehicle 10 from the energy source 18 for the motor vehicle 10 for filling the energy storage device 16 of the motor vehicle 10 is determined. A second position P2 of a mobile access authorization device 22 for a person 24 to the motor vehicle 10 is determined by means of a further position detection device 26 of the access authorization device 22. If the motor vehicle 10 is within a predetermined first distance threshold 28, in particular in the so-called geofence, of the energy source 18, and if the second position P2 is within a second predetermined distance threshold 30 from the motor vehicle closure device 12, then the motor vehicle closure device 12 is actuated by means of an electronic computing device 32 of the motor vehicle closure device 12. In particular, opening the motor vehicle closure device 12 is then carried out.

In particular, FIG. 1 shows that a trajectory 34 of the person 24 is determined depending on the second position P2 and that the motor vehicle closure device 12 is actuated depending on the trajectory 34.

As an alternative to the example shown in FIG. 1, it may be envisaged that a fuel filler flap of a fluidic energy storage device is also suitably provided. However, as shown in FIG. 1, the charging flap 14 for the electrical energy storage device 16 is opened.

In addition, it may be provided that automated closing of the motor vehicle closure device 12 is carried out after a specified period of time after the motor vehicle closure device 12 has been actuated. In particular, however, during a filling process of the energy storage device 16, closing the motor vehicle closure device 12 may be inhibited.

In addition, it may be provided that the energy source 18 and/or the person 24 is/are also detected by means of a detection device 36 of the motor vehicle 10 and is/are also taken into account when actuating the motor vehicle closure device 12.

FIG. 2 shows a schematic perspective view of an embodiment of a motor vehicle 10, in particular on a digital map 38. In particular, a further position P3 of the energy source 18 can be compared with the current first position P1 of the motor vehicle 10 on the basis of the digital map 38 and on the basis of this the distance A from the energy source 18 can be determined.

In particular, the figures show that the mobile access authorization device 22 is provided and used in particular in the form of a so-called digital key. This mobile access authorization device 22 can be, for example, a mobile phone or a smart watch. The use of this digital key allows it to be located using so-called Ultra Wide Band technology with very high accuracy, in particular with an accuracy of less than 10 centimeters and with a high update rate, for example every 100 milliseconds. Here, different “car connectivity” options can be provided, for example according to the CCC (Car Connectivity Consortium) criterion. Furthermore, several keys can be recognized and tracked at the same time. The chronological sequence of the localization results in the trajectory 34. This trajectory 34 describes, for example, the path from a driver's or passenger's door to the motor vehicle closure device 12. For example, the location is started automatically when the engine is stopped or a door is opened. The trajectory 34 of the key or then again of the person 24 is continuously compared with known trajectories 34 to the motor vehicle closure device 12. A machine learning approach can also be used here.

Furthermore, it is known that there are already a large number of providers of public charging. Thus, there is already a database with the corresponding charging points that can be accessed. This, in particular, can be provided by the digital map 38. Furthermore, today's motor vehicles 10 are equipped with a global navigation system, such as GPS. This allows the motor vehicle 10 to determine its current first position P1. This means that the motor vehicle 10 can also build up its own database with previous charging locations, for example also taking into account the home of the person 22. When the motor vehicle 10 is changed from driving to parking, the position of the motor vehicle 10 is compared with both databases.

If the person 22 occupies a corresponding trajectory 34 to the motor vehicle closure device 12, and the current first position P1 of the motor vehicle 10 corresponds to a known charging point, then the motor vehicle closure device 12 is again automatically opened. This is done proactively, for example at a distance of two meters from the vehicle closure device 12. In the event of incorrect triggering despite the detection of charging points, which is recognized based on the continued trajectory 34, the motor vehicle closure device 12 closes again automatically.

### REFERENCE SIGN LIST

10 Motor vehicle
12 Motor vehicle closure device
14 Charging flap
16 Energy storage device
18 Energy source
20 Position detection device
22 Mobile access authorization device
24 Person
26 Further position detection device
28 First distance threshold value
30 Second distance threshold value
32 Electronic computing device
34 Trajectory
36 Detection device
38 Digital map
A Distance
P1 First position
P2 Second position
P3 Further position

1. -10. (canceled)

11. A method for actuating a motor vehicle closure device of a motor vehicle, the method comprising:
detecting a current first position of the motor vehicle based on a signal from a position detection device of the motor vehicle;
determining a distance of the motor vehicle from an energy source for the motor vehicle for filling an energy storage device of the motor vehicle;
determining a second position of a mobile access authorization device for a person to the motor vehicle based on a signal from a further position detection device of the access authorization device;
actuating the motor vehicle closure device using a controller of the motor vehicle closure device when the motor vehicle is within a predetermined first distance threshold from the energy source and when the second position is within a second predetermined distance threshold from the motor vehicle closure device.

12. The method as claimed in claim 11, wherein the motor vehicle closure device is opened as the actuation.

13. The method as claimed in claim 11, wherein a trajectory of the person is determined depending on the second position and the motor vehicle closure device is actuated depending on the trajectory.

14. The method as claimed in claim 11, wherein the motor vehicle closure device is provided for a filler cap of a fluidic energy storage device or for a charging flap of an electrical energy storage device.

15. The method as claimed in claim 11, wherein after a specified period of time after the motor vehicle closure device has been actuated, an automated closing of the motor vehicle closure device is carried out.

16. The method as claimed in claim 15, wherein during a process of filling the energy storage device, closure of the motor vehicle closure device is inhibited.

17. The method as claimed in claim 11, further comprising detecting the energy source or the person based on a signal from a detection device of the motor vehicle taken into account when actuating the motor vehicle closure device.

18. The method as claimed in claim 11, wherein a further position of the energy source is compared with the current first position of the motor vehicle on the basis of a digital map and on the basis of the distance of the motor vehicle from the energy source.

19. A non-transient computer-readable medium for actuating a motor vehicle closure device of a motor vehicle, wherein the computer-readable medium comprises instructions which, when executed by a controller, cause the controller to:
detect a current first position of the motor vehicle based on a signal from a position detection device of the motor vehicle;
determine a distance of the motor vehicle from an energy source for the motor vehicle for filling an energy storage device of the motor vehicle;
determine a second position of a mobile access authorization device for a person to the motor vehicle based on a further position detection device of the access authorization device; and
actuate the motor vehicle closure device when the motor vehicle is within a predetermined first distance threshold from the energy source and when the second position is within a second predetermined distance threshold from the motor vehicle closure device.

20. The non-transient computer-readable medium of claim 19, wherein the motor vehicle closure device is opened as the actuation.

21. The non-transient computer-readable medium of claim 19, wherein a trajectory of the person is determined depending on the second position and the motor vehicle closure device is actuated depending on the trajectory.

22. The non-transient computer-readable medium of claim 19, wherein the motor vehicle closure device is provided for a filler cap of a fluidic energy storage device or for a charging flap of an electrical energy storage device.

23. The non-transient computer-readable medium of claim 19, wherein
after a specified period of time after the motor vehicle closure device has been actuated, an automated closing of the motor vehicle closure device is carried out; and
during a process of filling the energy storage device, closure of the motor vehicle closure device is inhibited.

24. The non-transient computer-readable medium of claim 19, wherein the computer-readable medium further comprises instructions which, when executed by a controller, cause the controller to detect the energy source or the person based on a signal from a detection device of the motor vehicle taken into account when actuating the motor vehicle closure device.

25. The non-transient computer-readable medium of claim 19, wherein the computer-readable medium further comprises instructions which, when executed by a controller, cause the controller to compare a further position of the energy source with the current first position of the motor vehicle on the basis of a digital map and on the basis of the distance of the motor vehicle from the energy source.

26. A motor vehicle closure device for a motor vehicle, wherein the motor vehicle closure device is configured to:
detect a current first position of the motor vehicle based on a signal from a position detection device of the motor vehicle;
determine a distance of the motor vehicle from an energy source for the motor vehicle for filling an energy storage device of the motor vehicle;
determine a second position of a mobile access authorization device for a person to the motor vehicle based on a further position detection device of the access authorization device; and
open when the motor vehicle is within a predetermined first distance threshold from the energy source and when the second position is within a second predetermined distance threshold from the motor vehicle closure device.

27. The motor vehicle closure device of claim 26, wherein a trajectory of the person is determined depending on the second position and the motor vehicle closure device is opened depending on the trajectory.

28. The motor vehicle closure device of claim 26, wherein the motor vehicle closure device is provided for a filler cap of a fluidic energy storage device or for a charging flap of an electrical energy storage device.

29. The motor vehicle closure device of claim 26, wherein the motor vehicle closure device is further configured to:
automatically close the motor vehicle closure device after a specified period of time after the motor vehicle closure device has been opened; and
inhibit closure of the motor vehicle closure device during a process of filling the energy storage device.

30. The motor vehicle closure device of claim 26, wherein the motor vehicle closure device is further configured to compare a further position of the energy source with the current first position of the motor vehicle on the basis of a digital map and on the basis of the distance of the motor vehicle from the energy source.
